(19) United States
(12) Patent Application Publication
(10) Pub. No.: US 2013/0009110 A1
(43) Pub. Date: Jan. 10, 2013

(54) CONDUCTIVE COMPOSITE MATERIAL CONTAINING A THERMOPLASTIC POLYMER AND CARBON NANOTUBES

(75) Inventors: Benoit BRULE, Beaumont Le Roger (FR); Nicolas Devaux, Etreville (FR); Patrick M. Piccione, Pau (FR); Eric Gamache, Bernay (FR); Catherine Bluteau, Orthez (FR); Nour-Eddine El Bounia, Orthez (FR)

(73) Assignee: Arkema France, Colombes (FR)

(21) Appl. No.: 13/543,024

(22) Filed: Jul. 6, 2012

Related U.S. Application Data
(62) Division of application No. 12/444,912, filed on Dec. 4, 2009, now abandoned.
(60) Provisional application No. 60/878,821, filed on Jan. 5, 2007.

(30) Foreign Application Priority Data
Oct. 19, 2006 (FR) 06.54384

(51) Int. Cl. H01B 1/24; B29C 45/00; B82Y 40/00

(52) U.S. Cl. 252/511; 264/328.1; 977/842

(57) ABSTRACT

Methods for controlling and improving the conductivity of thermoplastic polymer composites containing CNTs or even for making these materials conductive when they are initially insulating. For example, methods including either injection moulding or extrusion at a temperature above the melting temperature of the polymer, or a subsequent heat treatment step of said composite obtained by injection moulding or extrusion.

### CROSS REFERENCE TO RELATED APPLICATIONS

This application is a divisional application of Ser. No. 12/444,912, filed Apr. 9, 2009, which is a national stage application of PCT/FR07/52050, filed Oct. 1, 2007, and claims benefit of Provisional Application No. 60/878,821, filed Jan. 5, 2007, and French Application No. 06.54384 filed on Oct. 19, 2006.

### TECHNICAL FIELD

The present invention relates to a conductive composite based on a thermoplastic polymer and on carbon nanotubes (CNTs), and the methods for preparing said conductive composite, the methods comprising either injection moulding or extrusion, or a subsequent heat treatment step of said composite.

### BACKGROUND

Carbon nanotubes are well-known and used for their excellent electrical and thermal conductivity properties and also their mechanical properties. Thus they are increasingly used as additives to provide materials, especially macromolecular type materials, with these electrical, thermal and/or mechanical properties (WO 91/03057, U.S. Pat. No. 5,744,235, U.S. Pat. No. 5,445,327, U.S. Pat. No. 5,663,230).

Applications of carbon nanotubes are found in many fields, especially in electronics (depending on the temperature and their structure, they may be conductors, semiconductors or insulators), in engineering, for example for reinforcing composites (carbon nanotubes are one hundred times stronger and six times lighter than steel) and in electrical engineering (they may elongate or contract via charge injection).

Mention may be made, for example, of the use of carbon nanotubes in macromolecular compositions intended for packaging electronic components, for manufacturing fuel lines, clothing or antistatic clothing, in thermistors, or electrodes for supercapacitors, etc.

In U.S. Pat. No. 6,090,459, the authors describe multilayer pipes obtained by a coextrusion process, in which the inner layer is made from a thermoplastic polymer containing carbon nanotubes and is electrically conductive, for which the surface resistivities measured are less than 10⁶ ohms/square. The quantity of CNTs is preferably between 2% and 7% by weight and the polymers are, for example, polyamides with Mₙ greater than 4000 g/mol⁻¹ and preferably greater than 10000 g/mol⁻¹. The electrical conductivity of the inner layer is used to avoid explosions by dissipating the static electricity generated during the transport of certain materials in the tube.

In processes for converting thermoplastic polymer materials, it is known that extrusion or injection moulding processes cause a much more pronounced orientation of the macromolecules than that observed in the compression moulding processes. In this context, it can be imagined that the CNTs present also are orientated together with the polymer macromolecules and therefore the conductive properties of the resulting composite are modified, even reduced.

The aim of the present invention is to provide methods for controlling and improving the electrical properties of thermoplastic polymer materials containing CNTs or else for making objects, that are initially insulating, conductive.

### SUMMARY

According to one embodiment, the invention aims to provide conditions for the method that enables the conductivity of thermoplastic composites containing CNTs to be increased or even controlled, in order to achieve a given target.

According to another embodiment, the invention aims to provide a method for making a thermoplastic composite object containing CNTs obtained by injection moulding or extrusion, that is initially insulating, conductive.

Finally, the invention aims to provide injection-moulded or extruded products that are conductive even at very low amounts of CNTs.

One subject of the present invention is a conductive composite based on a thermoplastic polymer and on carbon nanotubes (CNTs) comprising, by weight, an amount of CNTs of less than 6%, preferably less than 2% or more preferably between 0.2 and 2%.

The composite according to the invention has a surface resistivity of less than 1×10⁶ ohms, preferably less than 1×10⁴ ohms. The composite according to the invention is based on a thermoplastic polymer chosen from the group of polyamides, polyolefins, polyacetals, polyketones, polyesters or polyfluoropolymers or blends or copolymers thereof.

Preferably, the composite according to the invention is based on nylon-12 or PVDF and incorporates an amount of CNTs of less than 2%.

Another subject of the invention is a method for preparing a conductive composite based on a thermoplastic polymer and on carbon nanotubes (CNTs), in which the conversion of a composition comprising the thermoplastic polymer and the carbon nanotubes (CNTs) is carried out by injection moulding or extrusion at a conversion temperature above the melting temperature of the polymer Tₘ, preferably between Tₘ+30° C. and Tₘ+60° C., more preferably at a temperature between Tₘ+60° C. and Tₘ+150° C.

According to a particular embodiment of this method, the composition used incorporates an amount of CNTs of less than 6%, less than 2% or more preferably between 0.2 and 2%.

According to a particular embodiment of this method, the polymer used is a polyamide.

According to a particular embodiment of this method, the conversion temperature is between 240° C. and 400° C.

Another subject of the invention is a method for preparing a conductive composite based on a thermoplastic polymer and carbon nanotubes (CNTs) comprising the preparation of the composite followed by a heat treatment in which the composite is held at a temperature above the melting point of the polymer for 0.1 to 1800 seconds, preferably from 0.1 to 150 seconds and optionally subjected to a pressure between 0 and 300 bar, preferably between 125 and 250 bar.

According to a particular embodiment of this method, the composition used incorporates an amount of CNTs of less than 6%, less than 2% or more preferably between 0.2 and 2%.

According to a particular embodiment of the invention, the heat treatment used is chosen from flame treatment, injection/compression moulding, overmoulding, double bubble extrusion, laminating, film-joining methods, such as laser welding, ultrasound welding, high-frequency welding, IML (In-Mould Labelling), IMD (In-Mould Decoration), thermoforming or hot melt gluing.

The invention also targets the use of the composite obtained according to one of the methods in automotive, sport, electronics or packaging applications.

Other features and advantages of the invention will become apparent on reading the detailed description that follows.

### BRIEF DESCRIPTION OF THE DRAWINGS

FIG. 1 is a graph of Resistance versus Percent Nanotubes.

FIG. 1a is a graph of Resistance versus Extrusion Temperature.

FIG. 1b is a graph of Resistance versus Percent Nanotubes.

FIG. 2a is a bar graph of Surface Resistivity.

FIG. 2b is a bar graph of Surface Resistivity.

### DETAILED DESCRIPTION

### Carbon Nanotubes

The carbon nanotubes that can be used in the present invention are well known and are described, for example, in Plastic World November 1993 page 10 or else in WO 86/03455. They comprise, in a non-limiting way, those having a relatively high aspect ratio, and preferably an aspect ratio of 10 to about 1000. In addition, the carbon nanotubes that can be used in the present invention preferably have a purity of 90% or above.

### Thermoplastic Polymers:

The thermoplastic polymers that can be used in the present invention are especially all those prepared from polyamides, polyacetals, polyketones, polyacrylics, polyolefins, polycarbonates, polystyrenes, polyesters, polyethers, polysulphones, polyfluoropolymers, polyurethanes, polyamideimides, polyarylates, polyarylsulphones, polyethersulphones, polyarylene sulphurs, polyvinyl chlorides, polyetherim ides, polytetrafluoroethylenes, polyetherketones, and also copolymers or blends thereof.

Among the thermoplastic polymers that can be used, amongst others covered by this description, mention may more particularly be made of: polystyrene (PS); polyolefins and more particularly polyethylene (PE) and polypropylene (PP); polyamides (for example PA-6, PA-6,6, PA-11 and PA-12); polymethyl methacrylate (PMMA); polyether terephthalate (PET); polyethersulphones (PES); polyphenylene ether (PPE); polyvinylidene fluoride (PVDF); polystyrene/acrylonitrile (SAN); polyethyl ether ketones (PEEK); polyvinyl chloride (PVC); polyurethanes, made from soft polyether blocks that are the residues of polyether diols and hard blocks (polyurethanes) that result from the reaction of at least one diisocyanate with at least one short diol; the short diol chain extender may possibly be chosen from the glycols mentioned earlier in the description; the polyurethane blocks and the polyether blocks being linked by bonds resulting from the reaction of the isocyanate functional groups with the OH functional groups of the polyether diol; polyester urethanes, for example those comprising diisocyanate units, units derived from amorphous polyester diols and units derived from a short diol chain extender, chosen for example from the glycols listed above; the polyether-block-polyamide (PEBA) copolymers resulting from the copolycondensation of polyamide blocks having reactive end groups with polyether blocks having reactive end groups such as, amongst others: 1) polyamide blocks having diamine chain ends with polyoxyalkylene blocks having dicarboxylic chain ends; 2) polyamide blocks having dicarboxylic chain ends with polyoxyalkylene blocks having diamine chain ends obtained by cyanoethylation and hydrogenation of α,ω-dihydroxylated aliphatic polyoxyalkylene blocks known as polyether diols; and 3) polyamide blocks having dicarboxylic chain ends with polyether diols, the products obtained being, in this particular case, polyetheresteramides and polyether esters.

Mention may also be made of acrylonitrile-butadiene-styrene (ABS), acrylonitrile-ethylene-propylene-styrene (AES), methyl methacrylate-butadiene-styrene (MBS), acrylonitrile-butadiene-methyl methacrylate-styrene (ABMS) and acrylonitrile-n-butyl acrylate-styrene (AAS) resins, modified polystyrene gums, resins of polyethylene, polypropylene, polystyrene, polymethyl methacrylate, polyvinyl chloride, cellulose acetate, polyamide, polyester, polyacrylonitrile, polycarbonate, polyphenylene oxide, polyketone, polysulphone and polyphenylene sulphide, fluororesins, silicone resins, polyimide and polybenzimidazole resins, polyolefin elastomers, styrene elastomers such as styrene/butadiene/styrene block copolymers or styrene/isoprene/styrene block copolymers or their hydrogenated form, PVC, urethane, polyester and polyamide elastomers, polybutadiene thermoplastic elastomers such as 1,2-polybutadiene or trans-1,4-polybutadiene resins; polyethylene elastomers such as methyl carboxylate/polyethylene, ethylene/vinyl acetate and ethylene/ethylacrylate copolymers and chlorinated polyethylenes; and fluorinated thermoplastic elastomers.

The term “thermoplastic polymer that can be used” is also understood to mean all the random, gradient or block copolymers produced from homopolymers corresponding to the above description. This covers, in particular, SBS, SIS, SEBS, SB type block copolymers produced via the anionic route and SBM (polystyrene-co-polybutadiene-co-polymethyl methacrylate) type copolymers. This also covers the copolymers produced via controlled radical polymerization, such as, for example, the SABuS (polystyrene-co-polybutyl acrylate-co-polystyrene) and MABuM (polymethyl methacrylate-co-polybutyl acrylate-co-polymethyl methacrylate) type copolymers and all their functionalized derivatives.

The composites according to the invention are produced either from plain (raw or washed or treated) CNTs, or from CNTs blended with a polymer powder, or from CNTs coated/blended with a polymer or other additives.

The amount of CNTs in the composites is, according to the invention, less than 6%, less than 2% or more preferably between 0.2 and 2%.

### The Conversion Processes According to an Embodiment of the Invention:

The extrusion or injection-moulding methods used in the invention are well known to a person skilled in the art. In the conventional processes, the processing temperature is always greater than the melting temperature of the polymer.

It is known that the processing of thermoplastics has the effect of generating an orientation in the direction of flow. It therefore seems logical to presuppose that the CNTs will be oriented during the conversion in the direction of flow.

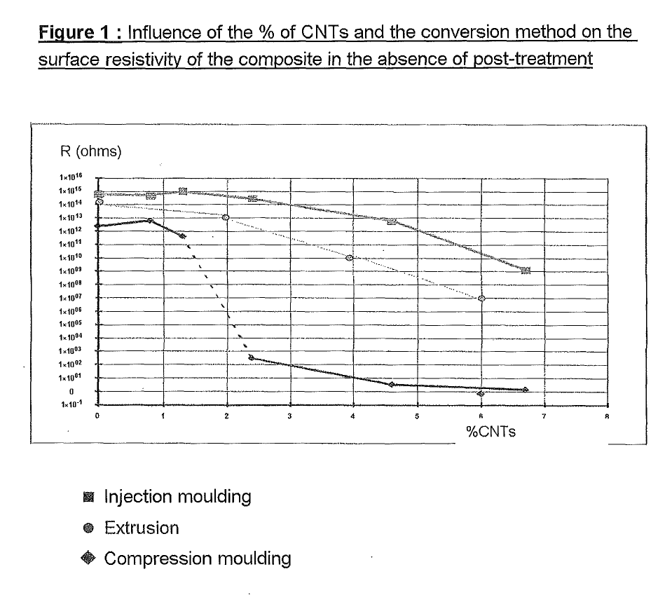

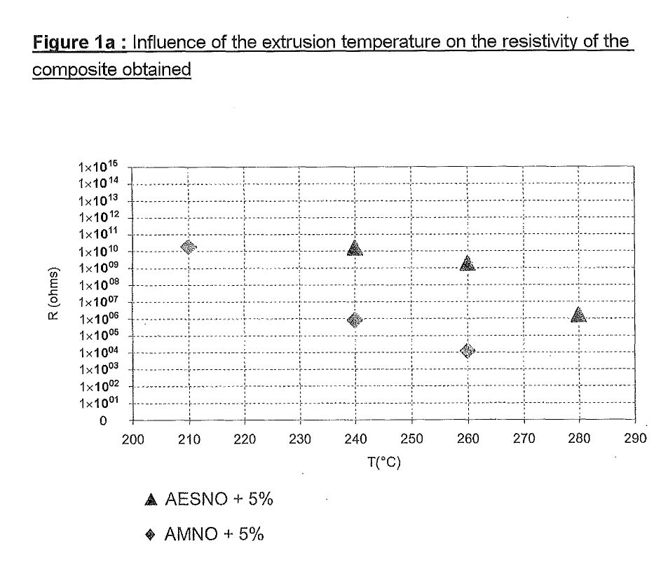

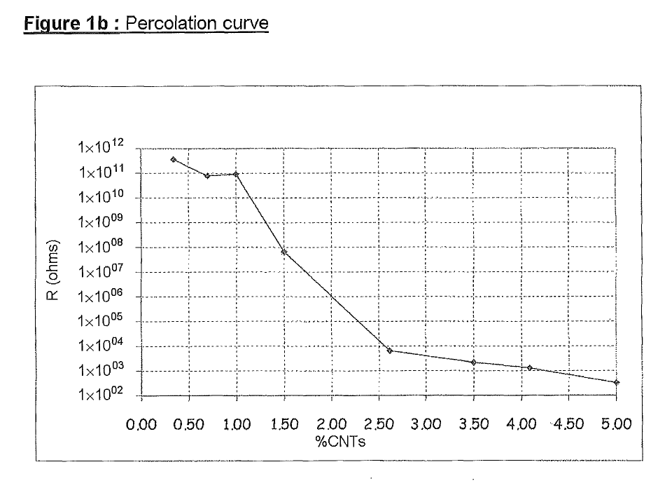

The Applicant has observed that the direct consequence of this orientation phenomenon is that it is necessary to increase the amount of CNTs to make the polymers conductive after extrusion and injection moulding. Particularly, whereas 2% of CNTs are sufficient to make a part obtained by compression moulding conductive, it requires more than 6% of CNTs to make the same parts, obtained by extrusion and injection moulding, conductive. These observations are illustrated in FIG. 1.

A composite is here considered to be a conductor when its surface and/or volume resistivity is less than 1×10⁶ ohms and to be an insulator when its surface and/or volume resistivity is greater than 1×10⁶ ohms.

According to one embodiment, the invention therefore provides a method that allows the conductivity of thermoplastic composites containing CNTs to be increased, especially when the composition contains amounts of CNTs of less than 6%.

This effect is surprisingly obtained by modifying the processing temperature of the polymer in the conventional extrusion or injection-moulding processes. Thus, according to the invention, the injection moulding or extrusion is carried out at a polymer conversion temperature above the melting temperature of the polymer Tₘ, preferably between Tₘ+30° C. and Tₘ+60° C., more preferably at a temperature between Tₙ, +60° C. and Tₘ+150° C.

FIG. 1a shows the effect of increasing the conversion temperature, in particular during extrusion, on the reduction in the resistivity for polymer compositions comprising 5% of CNTs. For a same composition, the more the temperature increases, the more the resistivity decreases or the more the conductivity increases.

In addition, the influence of the viscosity of the matrix on the increase in the conductivity is also shown. Indeed, at a given extrusion temperature, the more fluid polymers result in more conductive composites.

It is therefore possible, owing to this method according to the invention, to improve the conductivity of conductive composites until reaching a resistivity of less than 1×10⁶ ohms with amounts of CNTs of less than 6%, around 5% or even 2% of less. This result is easily achieved by compression moulding. On the other hand, in order to obtain it by extrusion or by injection moulding, it is necessary to use higher processing temperatures, adjusted conversion parameters and fluid matrices.

These results show that it is possible to increase the conductive properties of objects obtained by injection moulding or extrusion, by increasing the conversion temperature of the polymer or by modifying other conversion parameters and by reducing the viscosity of the matrix. These results imply a certain economic advantage, especially due to the fact that the injection-moulding or extrusion processes are much more widely used than the simple compression moulding processes, and also due to the fact that these results are possible even in the presence of very low amounts of CNTs. The other technical advantage is that the mechanical properties remain close to those of the matrix alone, for example for low-temperature impact and mechanical modulus properties.

### The Methods of Subsequent Heat Treatment:

According to one embodiment, the invention also provides a method that enables a thermoplastic composite, which contains CNTs and is initially insulating, to be made conductive.

This method therefore consists in a first step for converting the thermoplastic composite composition containing less than 6% of CNTs and obtaining an insulating object, that is to say that has a resistivity greater than 1×10⁶ ohms.

Step 1 may be any type of thermoplastic conversion known to a person skilled in the art. Mention may be made, for example, of injection moulding, extrusion, rotomoulding, overmoulding, thermoforming, laminating, extrusion-blow moulding or injection-blow moulding.

This step is followed by a heat treatment of the previously obtained object. The heat treatment consists in maintaining the composite at a temperature greater than the melting point of the polymer for 0.1 to 1800 seconds, preferably from 0.1 to 150 seconds. The composite may also optionally be subjected to a pressure between 0 and 300 bar, preferably between 125 and 250 bar.

Among the industrial processing methods which may possibly be used to apply the heat treatments used according to the invention, mention may be made of flame treatment, injection/compression moulding, overmoulding, double bubble extrusion, laminating, film-joining methods, such as laser welding, ultrasound welding, high-frequency welding, IML (In-Mould Labelling), IMD (In-Mould Decoration), thermoforming or hot melt gluing.

It is therefore possible, owing to this method according to the invention, to convert insulating composite objects into conductive composite objects and this until reaching a conductivity of less than 1×10⁶ ohms with amounts of CNTs of less than 6%, around 5% or even 2% of less. These results are not possible to be attained by conventional extrusion/injection-moulding processes without subsequent heat treatment.

These results show that it is possible to make insulating composite objects conductive by subjecting them to a simple heat treatment at a temperature above the melting temperature of the polymer. The control of the parameters (temperature, compression, time) for the subsequent heat treatment of the insulating moulded composites enables the conductive properties of these composites to be modulated and this at very low amounts of CNTs.

These results imply a certain economic advantage, especially due to the fact that the injection-moulding and/or extrusion processes are much more widely used than the simple compression-moulding processes, due to the fact that these results are possible even in the presence of very low amounts of CNTs and also due to the fact that a simple heat treatment is applied here to an object already prepared by an entirely conventional method.

### The Conductive Composites According to an Embodiment of the Invention:

According to another subject, the invention specifically targets a conductive composite, based on a thermoplastic polymer and on carbon nanotubes (CNTs), comprising an amount of CNTs of less than 2%, preferably between 0.2 and 2%. This material has a resistivity that is less than 1×10⁶ ohms, even less than 1×10⁴ ohms.

This conductive composite is obtained from methods and components and compositions described above, namely methods based on injection moulding, extrusion or compression moulding. The composites according to the invention are especially bulk objects, the thickness of which is at least 500 μm, or else objects in film form.

The invention also targets the use of the conductive composite obtained by the method according to the invention in automotive, sport, electronics or packaging applications.

Of course, the present invention is not limited to the examples and to the embodiments described and represented, but it is capable of numerous variants accessible to a person skilled in the art.

### EXAMPLES

In the examples below, two PA-12s of different melt flow index were used. The AMNO PA-12 is a fluid PA-12. The AESNO PA-12 is a viscous PA-12. The table below supplies the viscosities of AMNO TLD and of AESNO TL at 500 s⁻¹ for 3 temperatures (240, 260 and 280° C.).

| | | | Rabinowitsch |
|---|---|---|---|
| PA-12 | Temperature | Shear rate | viscosity |
| grade | (° C.) | (s⁻¹) | (Pa · s) |
| AMNO TLD | 240 | 500 | 135 |
| | 260 | 500 | 88 |
| | 280 | 500 | 59 |
| AESNO TL | 240 | 500 | 586 |
| | 260 | 500 | 457 |
| | 280 | 500 | 359 |

### Example 1

### Conditions of the Method for Improving the Conductivity or for Reaching the Desired Conductivity Target

The CNT/PA-12 composites were obtained by compounding, in a 30 mm twin-screw extruder, a masterbatch containing 20% of CNTs in a fluid PA-12 with the AMNO or AESNO PA-12 so as to obtain, at the end, amounts of CNTs of 1 and 5 wt %.

The granules obtained were extruded in a twin-screw, 15 cc μDSM microextruder at 100 rpm and at temperatures between 210 and 285° C. The die used was rectangular, 20×0.2 mm².

a—Effect of the Extrusion Temperature on the Conductivity

The surface resistivity values measured on the extruded films are given in FIG. 1a and the following table:

Resistivity of extruded film in ohms

| Extrusion T | AMNO + 5% CNT | AESNO + 5% CNT |
|---|---|---|
| 210° C. | 1.9 × 10¹⁰ | |
| 240° C. | 8.1 × 10⁵ | 1.7 × 10¹⁰ |
| 260° C. | 1.2 × 10⁴ | 2 × 10⁹ |
| 280° C. | | 1.7 × 10⁶ |

The results show that an increase in the conversion temperature makes it possible to reduce the resistivity for a given formulation (cf. FIG. 1a where, in AMNO matrix, the increase in the extrusion temperature enables a 6-decade reduction in resistivity). Thus, for a same formulation, the higher the processing temperature, the better the conductivity.

In addition, the results show that the fluid-based formulations are of the type to promote conductive properties.

b—Effect of the Injection-Moulding Mould Temperature on the Conductivity

Pellets of Kynar 721 PVDF having 2% CNT 5056 were injection-moulded with a DSM microcompounder under the following conditions: Tₑₓₜᵣ=230° C., 100 rpm, 8 minutes of compounding, Tᵢₙⱼ=230° C. and T_{mould}=135-160° C. The injected pellets had a diameter of 24.50 mm and a thickness of 1.56 mm. The pellets injected into the moulds at 135 or 145° C. had, in both cases, volume resistivities >10⁶ ohms·cm. At 160° C. a resistivity of 170-180 ohms·cm was obtained.

c—Conductive Extruded Objects Having a Low Content of CNTs

By increasing the processing temperature, the electrical percolation is shifted towards low CNT contents. AMNO/CNT blends with an amount of CNTs between 0.35 and 5% were produced by dry blending the compound having 5% of CNTs and virgin AMNO. Resistance measurements on extruded rods (diameter 1 mm, μDSM) show that 2% of CNTs are sufficient to obtain electrical conductivity in AMNO (cf. FIG. 1b).

### Example 2

### Examples of the Method with Subsequent Heat Treatment

In the examples that follow, the compounds previously described, in an AMNO matrix, and with 5% or 0.7% of CNTs, were used and three types of sheets (thickness 2 mm) were obtained according to whether the methods used were:

a) simple compression moulding;
b) injection moulding; or
c) injection moulding followed by a heat treatment.

### Experimental Conditions:

Compression moulding: 260° C.

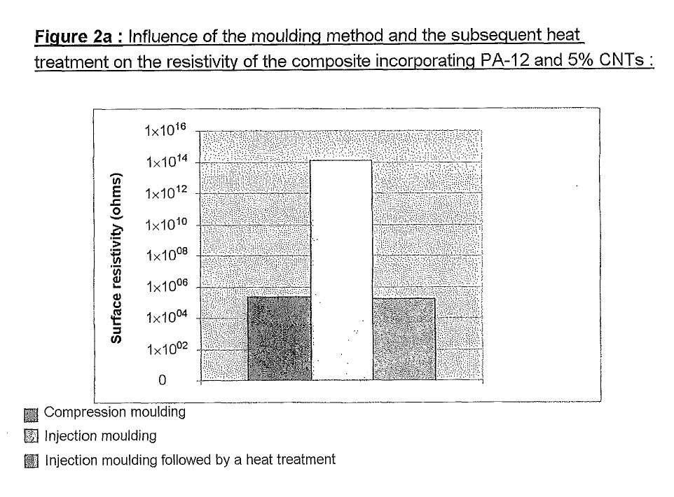

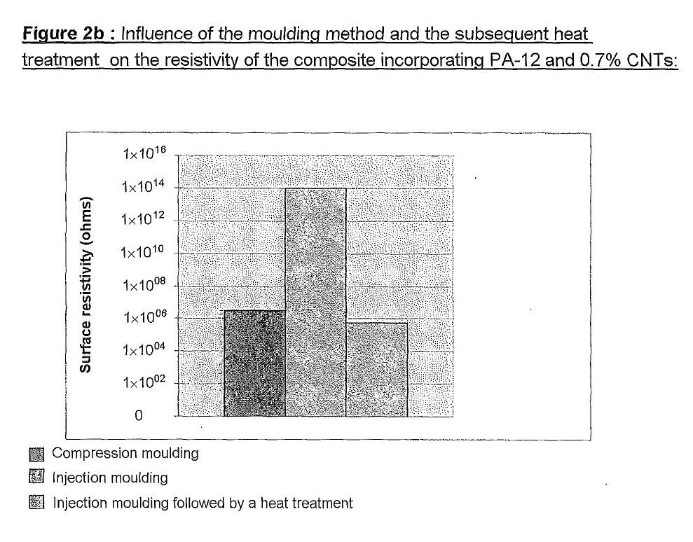

Injection moulding: side or central injection, 260° C., 120 cm³/s
Heat treatment: 260° C., t=10 min
The results are illustrated in FIGS. 2a and 2b. The results show the positive effect of a heat treatment for making insulating sheets, even with very low amounts of CNTs, conductive. Thus, conductive (R<1×10⁶ ohms) injection-moulded sheets are successfully produced with only 0.7% of CNTs.

### Example 3

### Another Example of a Composite Obtained, by Injection Moulding Followed by Heat Treatment, with PVDF+2% of CNTs

In this example, the heat treatment may or may not be combined with a compression moulding.

Pellets of Kynar 720 PVDF having 2% CNT 5056 were injection-moulded with a DSM microcompounder under the following conditions: Tₑₓₜᵣ=230° C., 100 rpm, 8 minutes of compounding, Tᵢₙⱼ=230° C. and T_{mould}=90° C. The injected pellets had a diameter of 24.50 mm and a thickness of 1.56 mm. The pellets all had volume resistivities >10⁶ ohms·cm. Post-curing tests were carried out following an experimental design coupling three parameters: the temperature, the pressure applied to the sample during the compression moulding and the compression moulding time. Each test was carried out on a single pellet.

The standard compression moulding of a pellet of this type was carried out according to the following protocol: 5 minutes of flow at 230° C., 2 minutes of compression moulding at 250 bar and cooling under pressure or outside the press.

The compression-moulding mould used was a mould with a diameter of 25 mm and a thickness of 1 mm.

In these tests, the post-curing protocol always began with 5 minutes of flow at the temperature indicated by the plan: the upper platen of the press is close to, but does not touch, the upper plate of the mould. This time is necessary in order to bring the pellet to temperature.

For pressures greater than 0 bar, there was contact between the upper platen of the press and the upper plate of the mould. At the end of the compression moulding, the mould was removed from the press and put under a weight of 4 kg distributed uniformly over the sample which corresponds to at least 1 bar. Cooling under a weight makes it possible for the PVDF to have a flat surface, a characteristic that is indispensable during the conductivity measurements.

| Temper- | Pres- | | Pellet | | Min:max |
|---|---|---|---|---|---|
| ature | sure | Compression | thickness | Resistivity | resistivity |
| (° C.) | (bar) | moulding (s) | (mm) | (ohms · cm) | (ohms · cm) |
| 160 | 0 | 30 | 1.61 | NC | |
| 160 | 0 | 600 | 1.62 | NC | |
| 160 | 125 | 120 | 1.53 | NC | |
| 160 | 250 | 30 | 1.52 | NC | |
| 160 | 250 | 600 | 1.52 | NC | |
| 200 | 0 | 120 | 1.04 | 79.7 | 79:81 |
| 200 | 0 | 120 | 1.27 | 129 | 111:148 |
| 200 | 125 | 30 | 0.98 | 582 | 544:621 |
| 200 | 125 | 600 | 0.96 | 239 | 207:270 |
| 200 | 250 | 120 | 0.98 | 15500 | 12100:18800 |
| 200 | 250 | 120 | 0.98 | 7840 | 6820:8720 |
| 240 | 0 | 30 | 1.09 | 483 | 468:498 |
| 240 | 0 | 600 | 1.00 | 101 | 89:114 |
| 240 | 125 | 120 | 0.99 | 44.3 | 38:51 |
| 240 | 125 | 120 | 0.98 | 351 | 192:510 |
| 240 | 250 | 30 | 0.99 | 1440 | — |
| 240 | 250 | 600 | 0.96 | 35.1 | 20:50 |
| 240 | 250 | 120 | 1.04 | 27.3 | 26:29 |

NC: non-conductive.

The results show the possibility of adjusting the electrical properties of the composite by heat treatment. The results also show that it is when the temperature is above the melting temperature of the polymer that the conductivity appears and it is therefore the key parameter of this method.

1. Method for preparing a conductive composite based on a thermoplastic polymer and carbon nanotubes (CNTs), the method comprising:
preparing the conductive composite followed by a heat treatment in which the conductive composite is held at a temperature above the melting point of the polymer for 0.1 to 1800 seconds and optionally subjected to a pressure between 0 and 300 bar.

2. The method according to claim 1, in which the conductive composite is held at a temperature above the melting point of the polymer for from 0.1 to 150 seconds.

3. The method according to claim 1, in which the conductive composite is subjected to a pressure between 125 and 250 bar.

4. Method according to claim 1, in which the amount of CNTs in the composition is less than 6%.

5. Method according to claim 1, in which the amount of CNTs in the composition is less than 2%.

6. Method according to claim 1, in which the amount of CNTs in the composition is between 0.2 and 2%.

7. Method according to claim 1, in which the heat treatment is chosen from flame treatment, injection/compression moulding, overmoulding, double bubble extrusion, laminating, laser welding, ultrasound welding, high-frequency welding, IML (In-Mould Labelling), IMD (In-Mould Decoration), thermoforming or hot melt gluing.

8. Method according to claim 1, in which the conductive composite has a surface resistivity of which is less than 1×10⁶ ohms.

9. Method according to claim 1, in which the thermoplastic polymer is chosen from the group polyamides, polyacetals, polyketones, polyacrylics, polyolefins, polycarbonates, polystyrenes, polyesters, polyethers, polysulphones, polyfluoropolymers, polyurethanes, polyamideimides, polyarylates, polyarylsulphones, polyethersulphones, polyarylene sulphurs, polyvinyl chlorides, polyetherimides, polytetrafluoroethylenes, polyetherketones, blends thereof or copolymers thereof.

10. Method according to claim 1, in which the thermoplastic polymer is a polyamide

11. Method according to claim 1, in which the thermoplastic polymer is selected from nylon-12 or PVDF.

12. Method for preparing a conductive composite based on a thermoplastic polymer and carbon nanotubes (CNTs), the method comprising:
converting a composition comprising the thermoplastic polymer and the carbon nanotubes (CNTs) by injection moulding or extrusion at a conversion temperature above the melting temperature of the polymer Tₘ.

13. Method according to claim 12, in which the amount of CNTs in the composition is less than 6%.

14. The method according to claim 12, in which the amount of CNTs in the composition is less than 2%.

15. The method according to claim 12, in which the amount of CNTs in the composition is between 0.2 and 2%.

16. Method according to claim 12, in which the thermoplastic polymer is chosen from the group polyamides, polyacetals, polyketones, polyacrylics, polyolefins, polycarbonates, polystyrenes, polyesters, polyethers, polysulphones, polyfluoropolymers, polyurethanes, polyamideimides, polyarylates, polyarylsulphones, polyethersulphones, polyarylene sulphurs, polyvinyl chlorides, polyetherimides, polytetrafluoroethylenes, polyetherketones, blends thereof or copolymers thereof.

17. Method according to claim 12, in which the polymer is a polyamide.

18. Method according to claim 17, in which the conversion temperature is between 240° C. and 400° C.

19. The method of claim 12, in which the conversion temperature is between Tₘ+30° C. and Tₘ+60° C.

20. The method of claim 12, in which the conversion temperature is between Tₘ+60° C. and Tₘ+150° C.
